(19) United States
(12) Patent Application Publication
(10) Pub. No.: US 2015/0032690 A1
(43) Pub. Date: Jan. 29, 2015

(54) VIRTUAL SYNCHRONIZATION WITH ON-DEMAND DATA DELIVERY

(71) Applicant: Microsoft Corporation, Redmond, WA (US)

(72) Inventors: Zabir Hoque, Seattle, WA (US); Tom Hill, Seattle, WA (US); Alexander Boczar, Redmond, WA (US); Jonas Keating, Redmond, WA (US)

(73) Assignee: Microsoft Corporation, Redmond, WA (US)

(21) Appl. No.: 13/950,461

(22) Filed: Jul. 25, 2013

(51) Int. Cl. G06F 17/30

(52) U.S. Cl. CPC G06F 17/30575
USPC 707/610

(57) ABSTRACT

A virtual synchronization methodology enables on-demand data delivery so that revisions are downloaded “just-in-time” to a client machine upon an observer's access of the files rather than downloading all the revisions upfront using the static and monolithic methodology in a conventional synchronization. When virtual synchronization is invoked, a preview of the changes in the file state that have occurred since the last synchronization is obtained and used to generate virtualized files with which the observer can interact and see the changes as if the files were actually synchronized. A virtualized file is then populated with actual data on-demand when accessed by the observer or by a system or process that is operating on the client machine.

### BACKGROUND

Version control systems typically track the historical state of data within a file or a collection of files termed a repository. Such systems typically allow editors to modify files and submit their changes to the version control system's change tracking database server. These submitted changes, termed “revisions,” become monotonically increasing versions of the original file. Interested parties can observe newer revisions by explicitly downloading a revision from the version control system's tracking database for local storage at a client machine in a process known as “synchronization.” In conventional synchronization, observers synchronize a repository's entire latest file state to their machine in one operation. This common and recommended synchronization methodology can become prohibitively expensive as the number of files and the repository data size increase.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A virtual synchronization methodology enables on-demand data delivery so that revisions are downloaded “just-in-time” to a client machine upon an observer's access of the files rather than downloading all the revisions upfront using the static and monolithic methodology in a conventional synchronization. When virtual synchronization is invoked, a preview of the changes in the file state that have occurred since the last synchronization is obtained and used to generate virtualized files with which the observer can interact and see the changes as if the files were actually synchronized. A virtualized file is then populated with actual file data on-demand when accessed by the observer or by a system or process that is operating on the client machine.

In an illustrative example, the virtual synchronization methodology interacts with a version control system to obtain the preview and generate the virtualized files on the client machine. A flush operation can then be performed to notify the version control system to update its view of the client machine as if the synchronization had actually been performed in a conventional manner. The virtualized files are implemented using stub files into which metadata is written. The metadata is used to locate the actual file data that is populated into a stub file when a virtualized file is later accessed.

In other illustrative examples, a user interface on the client machine is configured to enable an observer to choose between virtual and conventional synchronization when performing a given file synchronization. Both methodologies can co-exist and be supported on a client machine and a version control system without modifications to the system and the workflow of the virtual synchronization does not impact the workflow of the conventional synchronization. Synchronization may also be toggled between virtual and conventional methods according to rules and/or stored user preferences.

Advantageously, virtual synchronization with on-demand data delivery enables observers to only spend resources (e.g., time, hard disk space, network bandwidth, etc.) on files that they actually access instead of having to bear the costs to locally replicate all files, some of which the observer may not actually need and may never access. The on-demand data delivery is transparent to the observer and no changes in user behaviors are needed in order to obtain its benefits. On-demand data delivery is performed upon file access and observers do not need to explicitly specify the files they are interested in retrieving.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

It should be appreciated that the above-described subject matter may be implemented as a computer-controlled apparatus, a computer process, a computing system, or as an article of manufacture such as one or more computer-readable storage media. These and various other features will be apparent from a reading of the following Detailed Description and a review of the associated drawings.

### DESCRIPTION OF THE DRAWINGS

FIG. 1 shows an illustrative computing environment in which the states of remote files stored on a server are locally replicated at a client machine using a synchronization operation;

FIG. 2 shows an illustrative computing environment in which multiple client machines can synchronize a state of a repository through interactions with a version control system;

FIG. 3 shows an illustrative computing environment in which the states of remote files stored on a server are exposed as virtualized files at a client machine using a virtual synchronization operation;

FIG. 4 shows details of an illustrative virtualized file;

FIG. 5 is a diagram of an illustrative virtual synchronization process;

FIG. 6 is a flowchart of the virtual synchronization process shown in FIG. 5;

FIG. 7 is a diagram of an illustrative on-demand data delivery process;

FIG. 8 is a flowchart of the on-demand data delivery process shown in FIG. 7;

FIG. 9 shows operating details of an illustrative file system filter driver;

FIG. 10 shows an illustrative arrangement in which both conventional and virtual synchronization operations may be supported in a given computing environment;

FIG. 11 shows an illustrative timeline over which both conventional and virtual synchronization techniques are utilized;

FIG. 12 shows an illustrative arrangement in which synchronization operations are toggled between conventional and virtual synchronization processes according to rules and/or user preferences;

FIG. 13 is a simplified block diagram of an illustrative computer system such as a personal computer (PC) that may be used in part to implement the present virtual synchronization with on-demand data delivery; and

FIG. 14 shows a block diagram of an illustrative computing platform that may be used in part to implement the present virtual synchronization with on-demand data delivery.

Like reference numerals indicate like elements in the drawings. Elements are not drawn to scale unless otherwise indicated.

### DETAILED DESCRIPTION

FIG. 1 shows an illustrative computing environment 100 in which the states of remote files 105 stored on a server 108 are locally replicated at a client machine 113 using a synchronization operation 118. The server 108 may be a file sharing server, for example, or a server that is utilized in a version control system. An observer 125 will typically synchronize the latest state of the remote files 105 to the local client machine 113 in one operation in order to locally replicate files, as indicated by reference numeral 128. However, this common synchronization methodology can become prohibitively expensive when a large number of files and/or files having large sizes need to be downloaded to the client machine 113. Such expense can be compounded as the number of observers and files to be synchronized increases.

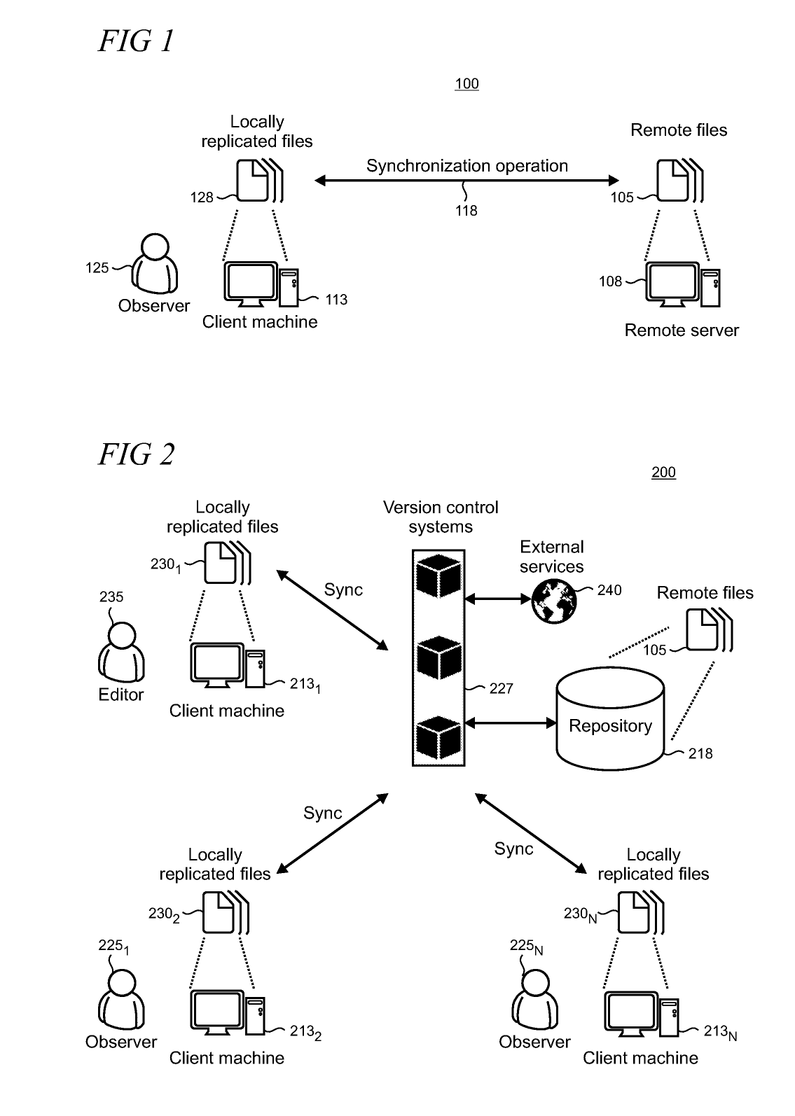

FIG. 2 shows an illustrative computing environment 200 that includes multiple observers 225_{1 . . . N} at client machines 213 interacting with a version control system. In the version control system context, the remote files 105 are typically stored in a repository 218 (it is noted that the term “repository” is also generally used to refer to the remotely stored files themselves). The observers 225 can synchronize a state of the repository 218 through interactions with one or more version control systems (as representatively indicated by reference numeral 227) to download and replicate files 230 locally. The version control system may be coupled to external services 240 in some cases.

The version control system 227 could be utilized to support a collaborative work environment, for example, in video game development or a multimedia authoring project in which many files are utilized that may be constantly updated and revised over the course of the project. Files may include dependencies in some cases. For example, a video game scene may need multiple files in order to be rendered correctly and an observer will typically want to ensure that all dependent files are downloaded when synchronized.

Editors (e.g., editor 235 in FIG. 2) may modify files and submit their changes to the version control system's change tracking database server (not shown). These revisions from the editors 235 thus comprise monotonically increasing versions of the original file. Newest revisions can be downloaded as the locally replicated files 230 through synchronization between the client machines 213 and the version control system 227.

Collaborative projects can often have a scale which results in the repository 218 being very large. Using the common synchronization methodology noted above, observers 225 will need to spend resources (e.g., time, hard disk space, network bandwidth, etc.) when synchronizing many files that are downloaded and stored locally. A given observer 225 is often only interested in files for which the observer is directly involved as part of a project, thus some of the synchronized and locally replicated files may never be opened and accessed at all. Since the quantity and/or sizes of files under version control can be very large it is also often impractical for observers to individually specify which files and which revisions of those file they are particularly interested in. Such problems may be compounded since the repository's collection of files can change over time, for example as files are edited and revised by project collaborators.

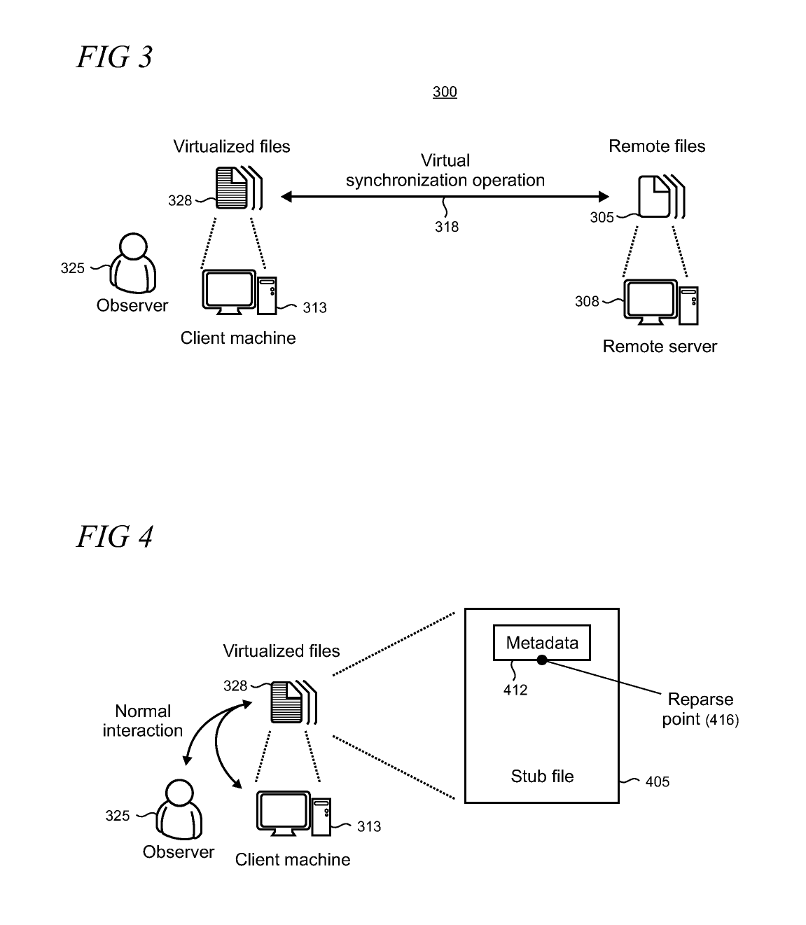

The problems associated with the common synchronization methodology where a repository's entire latest file state is synchronized to the local client machine in one operation may be addressed by the present on-demand data delivery using virtualized files. FIG. 3 shows an illustrative computing environment 300 in which the states of remote files 305 stored on a server 308 are exposed as virtualized files to an observer 325 at a client machine 313 using a virtual synchronization operation 318. Such virtual synchronization enables the observer 325 to see the changes in the remote files 305 that have occurred since the last synchronization. However, the actual downloading of file data is postponed to some future point in time when and if the observer 325 attempts to access the file, for example to see and/or edit its contents. That is, the delivery of the actual file data for any given virtualized file is implemented on-demand upon such file access by the observer 325. On-demand delivery may also be referred to as “just-in-time” delivery and the terms are often used synonymously.

As shown in FIG. 4, the observer 325 and various systems/processes on the client machine 313 can interact with the virtualized files 328 as if they had been conventionally synchronized. In typical implementations this means that the observer 325 can see and navigate to the virtualized files 328 displayed by the client machine 313 in a window generated, for example, by a file manager, file browser, or similar application. One or more various file details such as name, size, type, date created, date last modified, author, etc., may also be associated with the virtualized files 328 and conventionally displayed by the client machine 313 to the observer 325.

Each of the virtualized files 328 in this illustrative example is implemented using a stub file 405. The stub file may also be referred to as a “ghost file.” The stub file 405 is utilized to store metadata 412 that can be used to support the interaction by the observer/systems with the virtualized files 328 but does not contain any actual file data. In addition, the metadata 412 is utilized to locate and download the appropriate actual data during a future on-demand data delivery operation. As shown in FIG. 4, the metadata 412 is stored at a reparse point 416 in the stub file 405. In an illustrative implementation, the reparse point 416 is implemented under the NTFS (New Technology File System) file system as a system object and provides a location to store user-defined data (i.e., the metadata 412) along with a reparse tag which uniquely identifies the reparse point author. Accordingly, the tag identifies the file as being virtualized (i.e., written by a virtual synchronization process) so that the file can be populated with actual file data when accessed at a later time. When the file with a reparse point is accessed, a file system filter associated with the data identified by the reparse tag is attempted to be located. If a file system filter is found, the filter processes the file as directed by the reparse data which, in this case is the metadata 412.

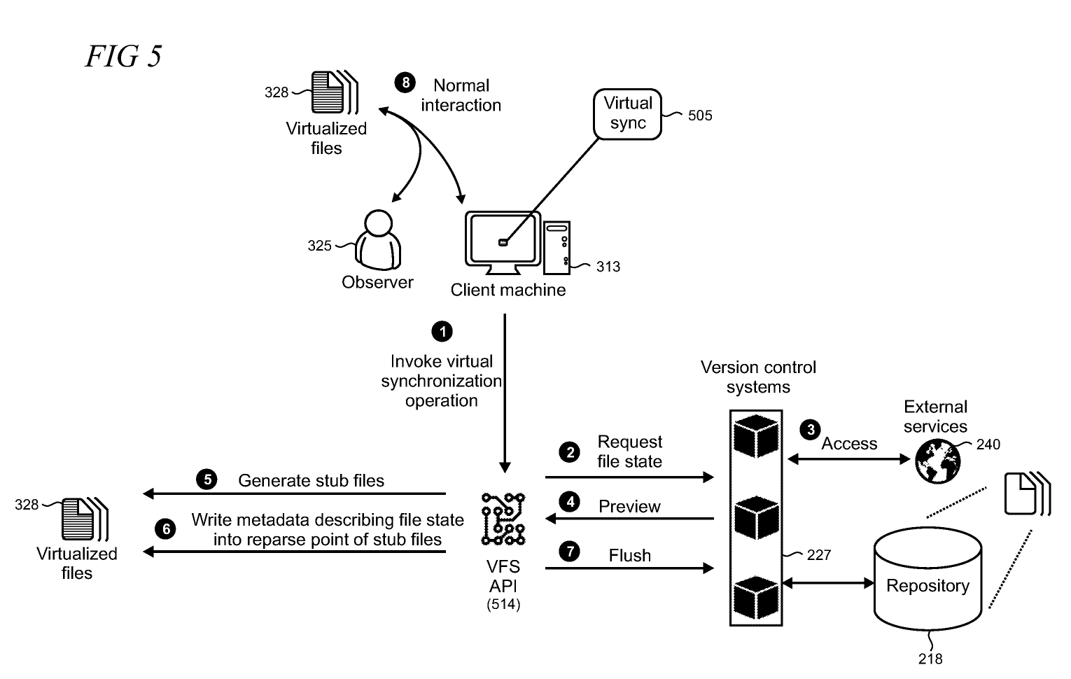

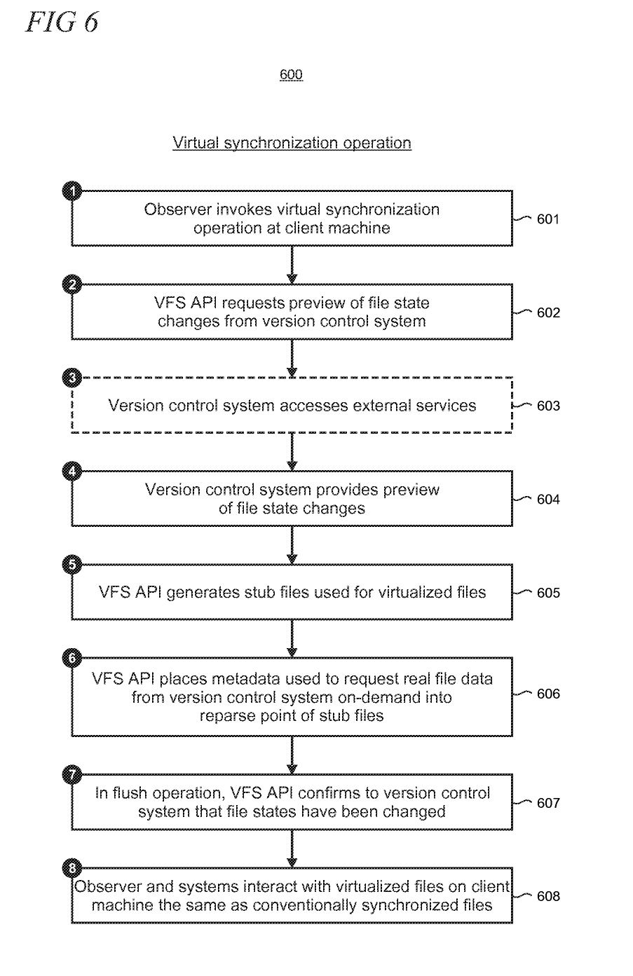

The use of the stub files 405 and reparse point 416 in support of virtual synchronization with on-demand data delivery is illustrated in an example shown in FIG. 5 and the associated method 600 shown in flowchart form in FIG. 6. Unless specifically stated, the methods or steps in the flowchart of FIG. 6 and those in the other flowcharts shown in the drawings and described below are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

At Step 1, the observer 325 invokes a virtual synchronization operation. In some implementations, a button 505 (FIG. 5) or similar object can be displayed on the client machine's user interface (UI) that the observer 325 can operate in order to launch the virtual synchronization. The launch command is received at a virtual file system (VFS) application programming interface (API) 514. It is noted that the name of the API 514 as “virtual file system” is arbitrary and is not intended to be limiting in how the API is implemented or in the features and functionalities it provides. In this illustrative example, the VFS API 514 is implemented as a dynamic link library (DLL) which encapsulates the VFS API functionality so that it may be leveraged by various services that may operate on the local client machine 313.

At Step 2, the VFS API 514 requests, from the version control system 227, a preview of the changes in file state compared to some nominal state. For example, the changes in file state may be those which occurred since the last synchronization at the client machine 313. The version control system 227 in this illustrative example is the same as shown in FIG. 2 and described in the accompanying text. In other words, the version control system 227 can be configured as a conventional system and the present virtual synchronization with on-demand data delivery can be implemented to augment the features and capabilities of the system without the need for modifications to such system. In alternative arrangements, the version control system can be built specifically to provide on-demand data delivery employing the principles described herein.

The preview is an expression of changes in file state that would occur if the synchronization were to be performed in a conventional manner. For example:
File a.txt is updated to revision 3;
File b.txt is added at revision 1;
File c.txt is deleted at revision 5 . . . .

Version control systems and file sharing servers/systems can generally provide such information upon request as a predicate to a conventional synchronization. At Step 3, the version control system may access external services 240 in order to produce the preview. This step is considered optional as indicated by the dashed lines in FIG. 6. The version control system 227 provides the preview of the changes in file state to the VFS API at Step 4. The VFS API, at Step 5, generates stub files to create the virtualized files 328 and writes metadata which describes the file state into the reparse point of each stub file at Step 6. As noted above the metadata enables virtualized files to be created so that the observer 325 can browse and interact with them normally and see various file details. In addition, by capturing file state, the metadata enables the actual file data to be located on the version control system and downloaded on-demand at a future time, as described above.

Once the VFS API 514 performs the actions at Steps 5 and 6 in response to the preview from the version control system 227, it notifies the system at Step 7 to update its view of the particular client machine 313 as if the synchronization had actually been performed in a conventional manner. That is, the state of the client machine 313 appears to the version control system as currently synchronized and that current synchronized state is confirmed by the notification. In this illustrative example, the provision of the notification from the VFS API to the version control system is termed a “flush” operation. The specific implementation details of a given flush operation can vary by context and version control system implementation. For example, in the context of a file sharing server, no explicit notification is needed for the server to update its view of client state.

At Step 8, the observer 325 and/or client machine systems may interact with the virtualized files 328 in a normal manner as if they were currently replicated files using a conventional synchronization, as discussed above.

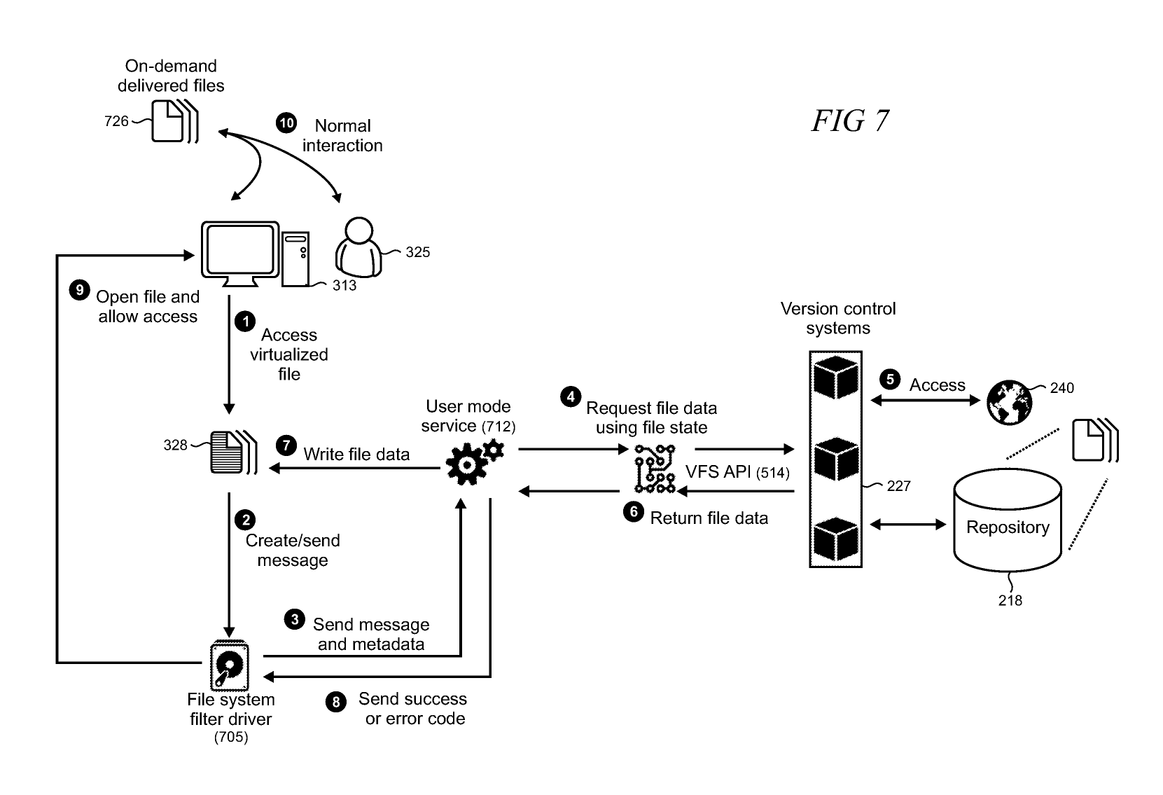

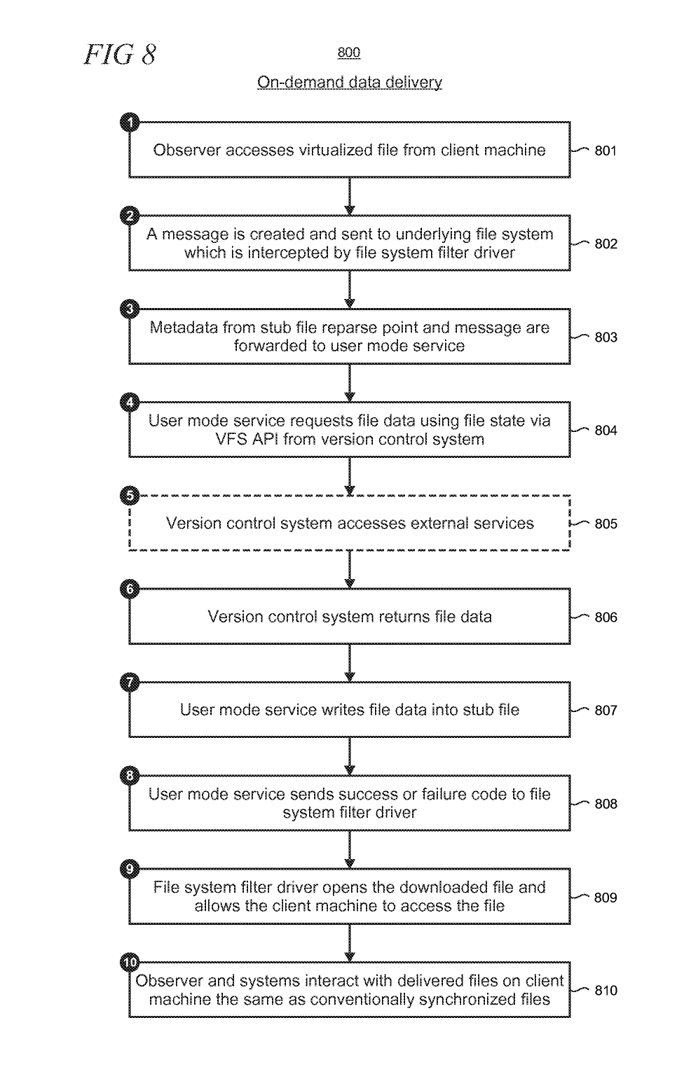

When the observer 325 accesses a virtualized file (for example, by double-clicking on it directly, or opening the file using an application), the actual file data is delivered on-demand. An example of on-demand data delivery is illustrated in the arrangement shown in FIG. 7 and the associated method 800 shown in flowchart form in FIG. 8. Upon access at Step 1, the operating system on the client machine 313 will create a message and send it down to the underlying filing system at Step 2. Since the stub file includes metadata stored in the file's reparse point as described above, the operating system will locate a file system filter driver 705 which is identified in the reparse tag (it will be appreciated that all file system filter drivers attached to a particular device will have an opportunity to inspect the message and reparse point).

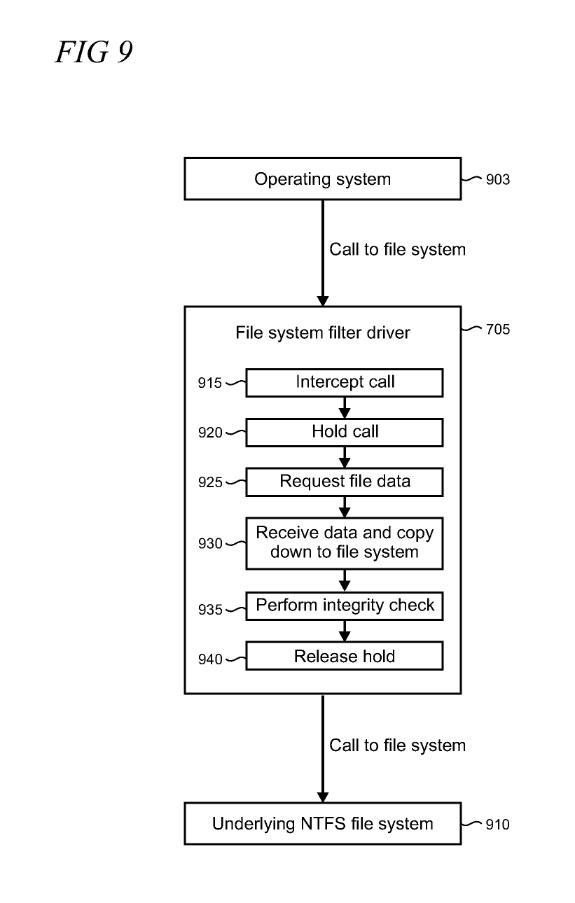

FIG. 9 shows operating details of the file system filter driver 705. As shown, when an attempt to open a virtualized file is made, the operating system 903 on the client machine will place a call to the underlying NTFS file system 910 that is instantiated on the client machine. The file system filter driver 705 will operate to essentially intercept the call (as indicated by reference numeral 915) and hold it (920) so that it does not reach the NTFS file system 910. The file system filter driver makes a request for the actual file data (925) through a user mode service as described below. The received data is copied down to the NTFS file system (930). An integrity check is performed (935) and if passed, the file system filter driver will release the hold (940) so that the call can be handled by the NTFS file system.

Returning to FIGS. 7 and 8, at Step 3 the file system filter driver 705 forwards the message and the metadata from the file's reparse point to the user mode service 712. At Step 4, the user mode service 712, acting through the VFS API 514, requests the actual file data from the version control system 227 using the file state as described by the metadata. Because the file state is specified, the exact file data of interest can be located by the version control system. The version control system may access external services 240 in order to fulfill the request at Step 5 in some cases. This step is considered optional as indicated by the dashed lines in FIG. 8.

The file data that is responsive to the request is returned at Step 6. In this particular illustrative example the user mode service is employed primarily to prevent system crashes in the event of unrecoverable errors in the on-demand data delivery. However, in alternative implementations, it may be desirable to implement some or all of the on-demand data delivery using one or more kernel mode processes.

At Step 7, the user mode service 712 attempts to write the file data into the stub file used to implement a virtualized file. The user mode service 712 will send an appropriate success or error code to the file system filter driver 705 at Step 8. If the file data is successfully written, then the file system driver 705 will enable the file to be opened and accessed at Step 9. The observer 325 and/or systems operating on the client machine 313 can then interact with the on-demand delivered file 726 in the same manner as with a conventionally synchronized file at Step 10. In typical implementations, the on-demand delivery is performed quickly enough that the process is entirely transparent to the observer. Once the file data is written to the client machine 313, the reparse point is removed and the file is handled and processed normally. However, the file may be subject to further virtual synchronization, for example, if further changes are made to the remote file in the repository.

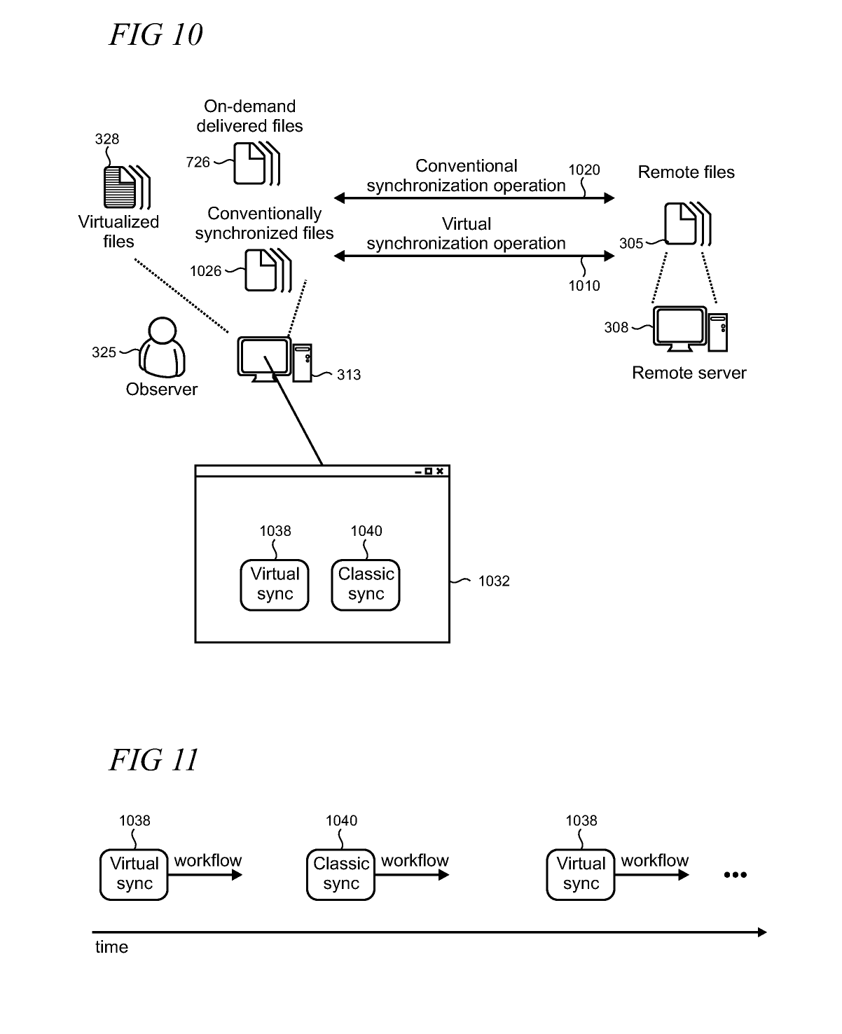

As discussed above, the present virtual synchronization with on-demand data delivery using virtual synchronization can be implemented to augment the capabilities and features of existing version control systems without modifications to those systems. In addition, in some implementations, as shown in FIG. 10, it may be desirable to support both virtual and conventional synchronization operations on the same machines, as respectively indicated by reference numerals 1010 and 1020. In such cases, the client machine 313 can simultaneously expose virtualized files 328, on-demand delivered files 726, and conventionally synchronized files 1026 to the observer 325. In some implementations, the client machine 313 may be configured so that the UI 1032 can display controls such as buttons 1038 and 1040 so that the observer can choose which particular synchronization methodology to use at a particular time.

As shown in the illustrative example in FIG. 11, the observer 325 uses a virtualized synchronization, then a conventional synchronization (termed a “classic sync” in this example), followed by another virtual synchronization over some arbitrary time interval. Each synchronization methodology operates independently and the workflow of the virtual synchronization does not negatively impact the workflow of the conventional synchronization in any way, and vice versa.

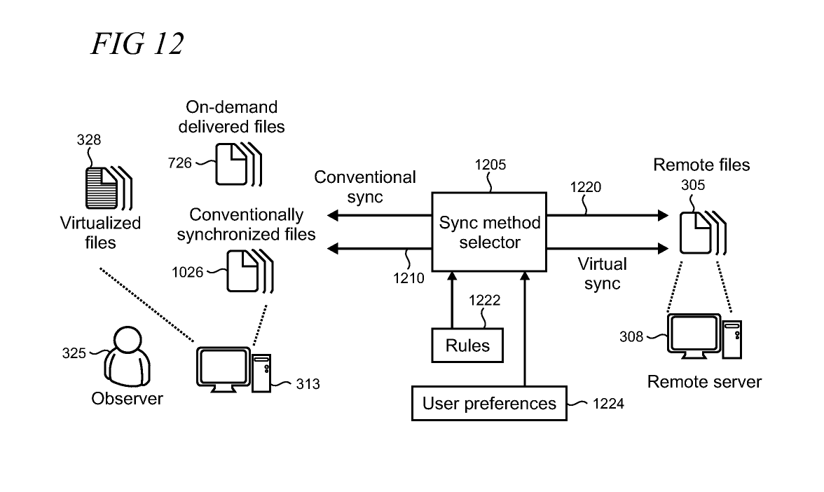

Synchronization may also be toggled between virtual methodologies in an automated manner. As shown in FIG. 12, a synchronization method selector 1205 is configured to select between virtual synchronization 1210 and conventional synchronization 1220 according to rules 1222 and/or user preferences 1224. The rules may comprise heuristics, algorithms, or other techniques that can select a synchronization methodology to be used to meet particular conditions or optimize certain characteristics.

For example, if network bandwidth is relatively plentiful (e.g., the client machine 313 is located in an enterprise environment and has access to a high capacity network), the rules 1222 can cause the synchronization method selector 1205 to select the conventional synchronization 1220 so that all the changes between local and remote file state are downloaded in one operation. Alternatively, if the client machine has only a low-bandwidth connection available (e.g., the client machine is obtaining network connectivity through a shared/tethered smartphone) the rules may state that the synchronization method selector 1205 utilizes virtual synchronization 1210.

Other rule examples can include conventionally synchronizing files that exceed a threshold size while virtually synchronizing files having a size that are under that threshold. Similarly, files stored in a particular directory having a date-modified attribute that is on or after a particular time/date can be conventionally synchronized while other files can be virtually synchronized. It will be appreciated that any of a variety of rules may be utilized that variously take into account file attributes, operating conditions, user behaviors, historical data, or the like.

Rules may be user-selectable in some cases and/or be used to implement user preferences. In typical implementations, a user interface (not shown) will expose various user-selectable criteria that can be used to drive synchronization methodology selection. For example, an observer may wish to specify preferences so that all the files associated with a given project are conventionally synchronized while non-project files are virtually synchronized.

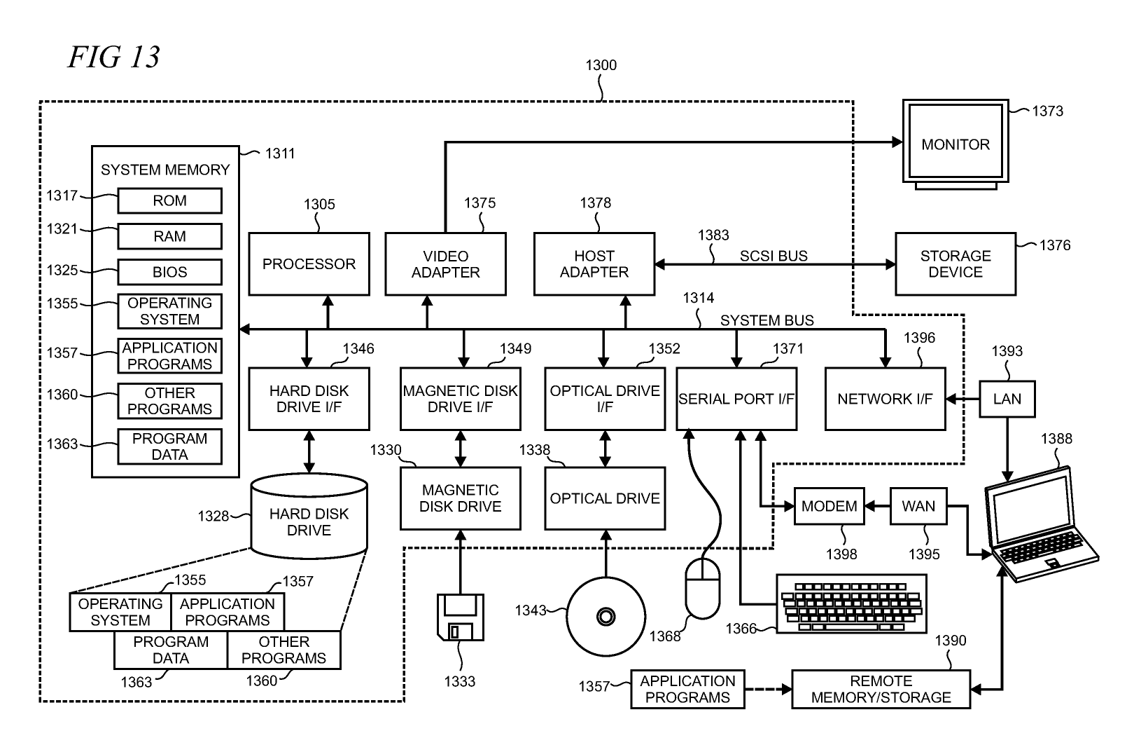

FIG. 13 is a simplified block diagram of an illustrative computer system 1300 such as a personal computer (PC), client machine, or server with which the present virtual synchronization with on-demand data delivery may be implemented. Computer system 1300 includes a processor 1305, a system memory 1311, and a system bus 1314 that couples various system components including the system memory 1311 to the processor 1305. The system bus 1314 may be any of several types of bus structures including a memory bus or memory controller, a peripheral bus, and a local bus using any of a variety of bus architectures. The system memory 1311 includes read only memory (ROM) 1317 and random access memory (RAM) 1321. A basic input/output system (BIOS) 1325, containing the basic routines that help to transfer information between elements within the computer system 1300, such as during startup, is stored in ROM 1317. The computer system 1300 may further include a hard disk drive 1328 for reading from and writing to an internally disposed hard disk (not shown), a magnetic disk drive 1330 for reading from or writing to a removable magnetic disk 1333 (e.g., a floppy disk), and an optical disk drive 1338 for reading from or writing to a removable optical disk 1343 such as a CD (compact disc), DVD (digital versatile disc), or other optical media. The hard disk drive 1328, magnetic disk drive 1330, and optical disk drive 1338 are connected to the system bus 1314 by a hard disk drive interface 1346, a magnetic disk drive interface 1349, and an optical drive interface 1352, respectively. The drives and their associated computer readable storage media provide non-volatile storage of computer readable instructions, data structures, program modules, and other data for the computer system 1300. Although this illustrative example shows a hard disk, a removable magnetic disk 1333, and a removable optical disk 1343, other types of computer readable storage media which can store data that is accessible by a computer such as magnetic cassettes, flash memory cards, digital video disks, data cartridges, random access memories (RAMs), read only memories (ROMs), and the like may also be used in some applications of the present virtual synchronization with on-demand data delivery. In addition, as used herein, the term computer readable storage medium includes one or more instances of a media type (e.g., one or more magnetic disks, one or more CDs, etc.). For purposes of this specification and the claims, the phrase “computer-readable storage medium” and variations thereof, does not include waves, signals, and/or other transitory and/or intangible communication media.

A number of program modules may be stored on the hard disk 1328, magnetic disk 1333, optical disk 1343, ROM 1317, or RAM 1321, including an operating system 1355, one or more application programs 1357, other program modules 1360, and program data 1363. A user may enter commands and information into the computer system 1300 through input devices such as a keyboard 1366 and pointing device 1368 such as a mouse. Other input devices (not shown) may include a microphone, joystick, game pad, satellite dish, scanner, trackball, touchpad, touch screen, touch-sensitive device, voice-command module or device, user motion or user gesture capture device, or the like. These and other input devices are often connected to the processor 1305 through a serial port interface 1371 that is coupled to the system bus 1314, but may be connected by other interfaces, such as a parallel port, game port, or universal serial bus (“USB”). A monitor 1373 or other type of display device is also connected to the system bus 1314 via an interface, such as a video adapter 1375. In addition to the monitor 1373, personal computers typically include other peripheral output devices (not shown), such as speakers and printers. The illustrative example shown in FIG. 13 also includes a host adapter 1378, a Small Computer System Interface (SCSI) bus 1383, and an external storage device 1376 connected to the SCSI bus 1383.

The computer system 1300 is operable in a networked environment using logical connections to one or more remote computers, such as a remote computer 1388. The remote computer 1388 may be selected as another personal computer, a server, a router, a network PC, a peer device, or other common network node, and typically includes many or all of the elements described above relative to the computer system 1300, although only a single representative remote memory/storage device 1390 is shown in FIG. 13. The logical connections depicted in FIG. 13 include a local area network (“LAN”) 1393 and a wide area network (“WAN”) 1395. Such networking environments are often deployed, for example, in offices, enterprise-wide computer networks, intranets, and the Internet.

When used in a LAN networking environment, the computer system 1300 is connected to the local area network 1393 through a network interface or adapter 1396. When used in a WAN networking environment, the computer system 1300 typically includes a broadband modem 1398, network gateway, or other means for establishing communications over the wide area network 1395, such as the Internet. The broadband modem 1398, which may be internal or external, is connected to the system bus 1314 via a serial port interface 1371. In a networked environment, program modules related to the computer system 1300, or portions thereof, may be stored in the remote memory storage device 1390. It is noted that the network connections shown in FIG. 13 are illustrative and other means of establishing a communications link between the computers may be used depending on the specific requirements of an application of virtual synchronization with on-demand data delivery.

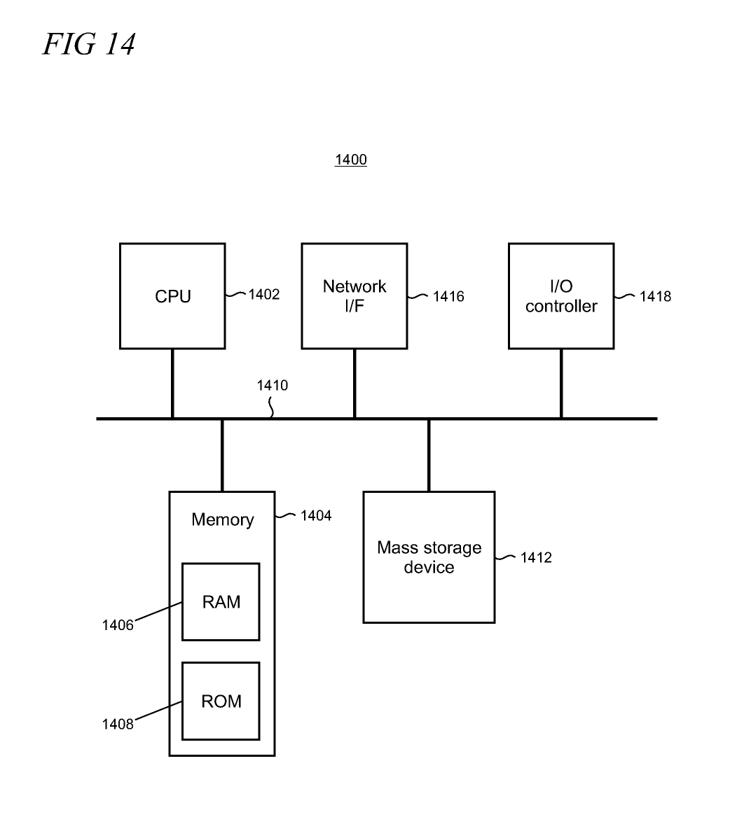

It may be desirable and/or advantageous to enable other types of computing platforms other than the local client machine 313 (FIG. 3) to implement the present virtual synchronization with on-demand data delivery in some applications. For example, the methodology may be readily adapted to run on fixed computing platforms and mobile computing platforms that have video capture capabilities. FIG. 14 shows an illustrative architecture 1400 for a computing platform or device capable of executing the various components described herein for providing virtual synchronization and on-demand data delivery. Thus, the architecture 1400 illustrated in FIG. 14 shows an architecture that may be adapted for a server computer, mobile phone, a PDA (personal digital assistant), a smartphone, a desktop computer, a netbook computer, a tablet computer, GPS (Global Positioning System) device, gaming console, and/or a laptop computer. The architecture 1400 may be utilized to execute any aspect of the components presented herein.

The architecture 1400 illustrated in FIG. 14 includes a CPU 1402, a system memory 1404, including a RAM 1406 and a ROM 1408, and a system bus 1410 that couples the memory 1404 to the CPU 1402. A basic input/output system containing the basic routines that help to transfer information between elements within the architecture 1400, such as during startup, is stored in the ROM 1408. The architecture 1400 further includes a mass storage device 1412 for storing software code or other computer-executed code that is utilized to implement applications, the file system, and the operating system.

The mass storage device 1412 is connected to the CPU 1402 through a mass storage controller (not shown) connected to the bus 1410. The mass storage device 1412 and its associated computer-readable storage media provide non-volatile storage for the architecture 1400. Although the description of computer-readable storage media contained herein refers to a mass storage device, such as a hard disk or CD-ROM drive, it should be appreciated by those skilled in the art that computer-readable media can be any available computer storage media that can be accessed by the architecture 1400.

Although the description of computer-readable storage media contained herein refers to a mass storage device, such as a hard disk or CD-ROM drive, it should be appreciated by those skilled in the art that computer-readable storage media can be any available storage media that can be accessed by the architecture 1400.

By way of example, and not limitation, computer-readable storage media may include volatile and non-volatile, removable and non-removable media implemented in any method or technology for storage of information such as computer-readable instructions, data structures, program modules or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), BLU-RAY, or other optical storage, magnetic cassettes, magnetic tape, magnetic disk storage or other magnetic storage devices, or any other medium which can be used to store the desired information and which can be accessed by the architecture 1400. For purposes of this specification and the claims, the phrase “computer-readable storage medium” and variations thereof, does not include waves, signals, and/or other transitory and/or intangible communication media.

According to various embodiments, the architecture 1400 may operate in a networked environment using logical connections to remote computers through a network. The architecture 1400 may connect to the network through a network interface unit 1416 connected to the bus 1410. It should be appreciated that the network interface unit 1416 also may be utilized to connect to other types of networks and remote computer systems. The architecture 1400 also may include an input/output controller 1418 for receiving and processing input from a number of other devices, including a keyboard, mouse, or electronic stylus (not shown in FIG. 14). Similarly, the input/output controller 1418 may provide output to a display screen, a printer, or other type of output device (also not shown in FIG. 14).

It should be appreciated that the software components described herein may, when loaded into the CPU 1402 and executed, transform the CPU 1402 and the overall architecture 1400 from a general-purpose computing system into a special-purpose computing system customized to facilitate the functionality presented herein. The CPU 1402 may be constructed from any number of transistors or other discrete circuit elements, which may individually or collectively assume any number of states. More specifically, the CPU 1402 may operate as a finite-state machine, in response to executable instructions contained within the software modules disclosed herein. These computer-executable instructions may transform the CPU 1402 by specifying how the CPU 1402 transitions between states, thereby transforming the transistors or other discrete hardware elements constituting the CPU 1402.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the architecture 1400 in order to store and execute the software components presented herein. It also should be appreciated that the architecture 1400 may include other types of computing devices, including hand-held computers, embedded computer systems, smartphones, PDAs, and other types of computing devices known to those skilled in the art. It is also contemplated that the architecture 1400 may not include all of the components shown in FIG. 14, may include other components that are not explicitly shown in FIG. 14, or may utilize an architecture completely different from that shown in FIG. 14.

Based on the foregoing, it should be appreciated that technologies for providing and using virtual synchronization with on-demand data delivery have been disclosed herein. Although the subject matter presented herein has been described in language specific to computer structural features, methodological and transformative acts, specific computing machinery, and computer-readable storage media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed:

1. A method for synchronizing a state of a repository to a local client machine, the method comprising the steps of:
obtaining a preview of changes between a current state of the local client machine and the state of the repository;
generating one or more virtualized files, the virtualized files reflecting the changes from the preview;
exposing the virtualized files to systems and processes executing on the local client machine; and
populating file data into a virtualized file on-demand when the virtualized file is accessed on the local client machine.

2. The method of claim 1 further including a step of making a request to a version control system in order to obtain the preview.

3. The method of claim 1 further including the steps of generating one or more stub files and utilizing the generated one or more stub files to implement respective one or more virtualized files.

4. The method of claim 3 further including a step of writing metadata into the one or more stub files, the metadata describing the changes between a current state of the local client machine and the state of the repository.

5. The method of claim 4 further including a step of writing the metadata into a reparse point of each of the one or more stub files, the reparse point including a tag to identify the metadata and the reparse being configured for invoking execution of a file system filter driver specified in the tag when a stub file is attempted to be opened.

6. The method of claim 3 further including a step of performing a flush operation subsequent to writing the metadata to the one or more stub files, the flush operation comprising a notification to a version control system that confirms that a state of the local client machine has been synchronized to a latest state of the repository.

7. The method of claim 1 further including a step of providing a user control operating on a user interface supported on the client machine for invoking the steps of obtaining, generating, and exposing.

8. The method of claim 1 further including a step of toggling between virtual synchronization and non-virtual synchronization, the toggling being performed in accordance with user selection, rules, or stored user preferences.

9. A system comprising:
a processor; and
a memory bearing instructions which, when executed by the processor perform a method for on-demand delivery of data into virtualized files, the method comprising the steps of
receiving a call to open a stub file associated with a file of interest, the stub file being one of a plurality of stub files utilized to implement the virtualized files and including metadata that describes a state of one or more remote files in a repository,
making a request for data to be populated into the stub file, the request including the descriptive metadata so that the requested data pertains to the file of interest,
receiving the data responsively to the request,
populating the data into the stub file to generate an on-demand delivered file, and
enabling the on-demand delivered file to be accessed.

10. The system of claim 9 further including a step of utilizing a user mode service for performing the steps of making the request, receiving the data, and populating the data.

11. The system of claim 10 further including a step of utilizing a file system filter driver to intercept and hold the call, and send the metadata to the user mode service.

12. The system of claim 11 further including a step of utilizing the file system filter driver to enable the call to reach an underlying file system once the stub file has been populated with the received data.

13. The system of claim 10 in which the user mode service interfaces with an application programming interface when requesting and receiving the data, the request being made to a version control system.

14. The system of claim 13 in which the application programming interface is implemented as a dynamic link library.

15. One or more computer-readable storage media storing instructions which, when executed by one or more processors disposed on a client machine, perform a method for virtual synchronization and on-demand data delivery, the method comprising the steps of:
receiving a preview of changes between a current state of a local client machine and a state of a repository storing one or more files;
generating one or more virtualized files, the virtualized files reflecting the changes from the preview;
exposing the virtualized files to systems and processes executing on the local client machine, the system and processes interacting with the virtualized files as if they are currently synchronized with the files in the repository;
receiving a call to open a stub file associated with a file of interest, the stub file being one of a plurality of stub files utilized to implement the virtualized files and including metadata that describes a state of the file of interest;
making a request for data to be populated into the stub file, the request including the descriptive metadata so that the requested data pertains to the file of interest;
receiving the data responsively to the request; and
populating the data into the stub file to generate an on-demand delivered file.

16. The one or more computer-readable storage media of claim 15 in which the method further includes a step of enabling the on-demand delivered file to be accessed.

17. The one or more computer-readable storage media of claim 16 in which the enabling comprises releasing a hold on the received call so it reaches an underlying file system operating on the local client machine.

18. The one or more computer-readable storage media of claim 17 in which the hold is released by a file system filter driver, the file system filter driver being identified by a tag in a reparse point of a stub file.

19. The one or more computer-readable storage media of claim 18 in which the reparse point is utilized to store the metadata.

20. The one or more computer-readable storage media of claim 15 in which the method further includes performing a non-virtual synchronization between the local client machine and the repository either before or after the virtual synchronization and on-demand data delivery.
